(19) United States
(12) Patent Application Publication
(10) Pub. No.: US 2018/0053169 A1
(43) Pub. Date: Feb. 22, 2018

(54) Middle device used to receive temporary onetime payment information from a NFC enabled smart device or digital wallet to process payment on a non NFC enabled point of sale terminal

(71) Applicant: Jason Lee James, Green Cove Springs, FL (US)

(72) Inventor: Jason Lee James, Green Cove Springs, FL (US)

(21) Appl. No.: 15/241,027

(22) Filed: Aug. 18, 2016

(51) Int. Cl. G06Q 20/20; G06Q 20/10; G06Q 20/32; G06Q 20/40

(52) U.S. Cl. CPC G06Q 20/204; G06Q 20/4016; G06Q 20/3278; G06Q 20/10

(57) ABSTRACT

A middle device used to temporally receive and process payment transactions generated through the use of a Near Field Communication or NFC enabled smart device or digital wallet application containing the stored payment information from a user's credit card or debit card and enabling the user to process a onetime payment through a point of sale terminals chip and pin processor or magnetic stripe reader.

### FIELD OF THE TECHNOLOGY

At least some of the embodiments disclosed herein relate, in general, to a middle device used to temporally receive, hold and process a form or method of payment, initiated on a user controlled smart NFC enabled device or mobile contactless electronic wallet system, more specifically for use on point of sale terminals or payment accepting systems that do not accept, or lack the ability to accept contactless payment methods, which would enable a user to process the payment though other methods such as, a magnetic stripe reader, chip and pin enabled terminal or a chip and signature enabled point of sale terminal.

### BACKGROUND OF THE INVENTION

With current advances in the credit card and debit card payment security fields many updates have emerged to help protect both consumers and merchants from fraudulent card activity and payment information theft. Two of the most commonly used payment security methods are the use of chip and pin or chip and signature that requires a chip embedded in the payment card, or contactless payment, which most commonly utilizes a form of close proximity data transfer referred to as Near Field Communication or NFC payment, both methods are able to secure the payment by processing the information with unique digital signature. The United States implemented new requirements in 2015 that would shift the liability to merchants who have not updated their payment methods to accept the more secured chip and signature payment forms, However due to the fast changing security requirements and the expensive cost of the software and hardware required for the implantations, many small merchants are unable to afford the equipment necessary to protect the transactions. Also in the case of many large retailers that have elected to simply not activate the NFC capability in terminals to accept payment methods from smart Near Field Communication devices in a effort to help reduce transaction fees while still avoiding liability for any fraudulent activity, which can leave both the consumers and payment processing companies at risk of either payment or identity theft. With the growth in consumer awareness towards the risk of identity theft and fraudulent card activity and annual increases of smart device users, the use of near field communication contactless payments are estimated to grow by over 216% by the end of 2016. Another added security measure that benefits from many NFC payment methods would be the use of biometric confirmation in order to process the payments before releasing the secured payment data. Aside from the many security benefits from NFC payments, many large companies have begun to offer incentives such as loyalty rewards and push notification coupons to consumer devices that choose to pay with these contactless payment forms. Today, however, many smart device users have not yet adapted to the mobile wallet platform due to the frustration of only a few large retailers and merchants accepting contactless payments. With a device capable of allowing the user to initiate a NFC payment on a terminal that would not be capable of processing a form of contactless payment under regular circumstances, while also not requiring the user to store the full payment information permanently would allow a greater ease to the user while helping to prevent fraud in the case that the device or payment data were compromised.

### SUMMARY

The present disclosure relates to a middle device used to temporally receive and process a secured onetime Near Field Communication payment initiated through a smart device or mobile application such as, a smart phone or mobile electronic wallet, to then utilize the secured payment information data on point of sale terminals that would only be capable of receiving payment processing data through a magnetic stripe reader or a chip and pin processing terminal, without the middle device being required to save or store the secured payment information. After the transaction has been completed or for a designated allotted time frame set by either the device user or the payment processing provider the middle device would delete all payment information and be unable to process future payments until initiated by the user.

### BRIEF DESCRIPTION OF DRAWINGS

The embodiments are illustrated by way of example and not limitation in the figures of the described drawings in which the references indicate similar elements.

FIG. 1 shows a simplified illustration of the receiving device hardware and components used to receive and process the payment information.

FIG. 2 shows an illustration of a smart device sending payment information through Near Field Communication to the receiving device utilizing a magnetic stripe reader to process the payment information.

FIG. 3 shows an illustration of a smart device sending payment information through Near Field Communication to the receiving device utilizing a Chip and pin or EMV Chip to process the payment information.

FIG. 4 shows an illustration of the steps used to process a payment initiated through a smart device or electronic payment card through the onetime payment device onto a terminal unable to process a contactless payment.

FIG. 5 shows an illustration of an example of the device utilizing the digital display with a randomized pin or postal code for secure online purchases.

### DETAILED DESCRIPTION OF DRAWINGS

The following description and drawings are illustrated and are not to be construed as limiting. Numerous specific details are described to provide a thorough understanding. However, in certain instances, well known or conventional details are not described in order to avoid obscuring the description. References to one or more embodiments in the present disclosure are not necessarily references to the same embodiment; and, such references mean at least one.

References in this specification to “one embodiment” or “an embodiment” means that a particular feature, structure or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The Present disclosure relates to a middle device used to receive temporary onetime payment information from a Near Field Communication enabled smart device or digital wallet and process the secured onetime payment on a non NFC updated or activated payment terminal.

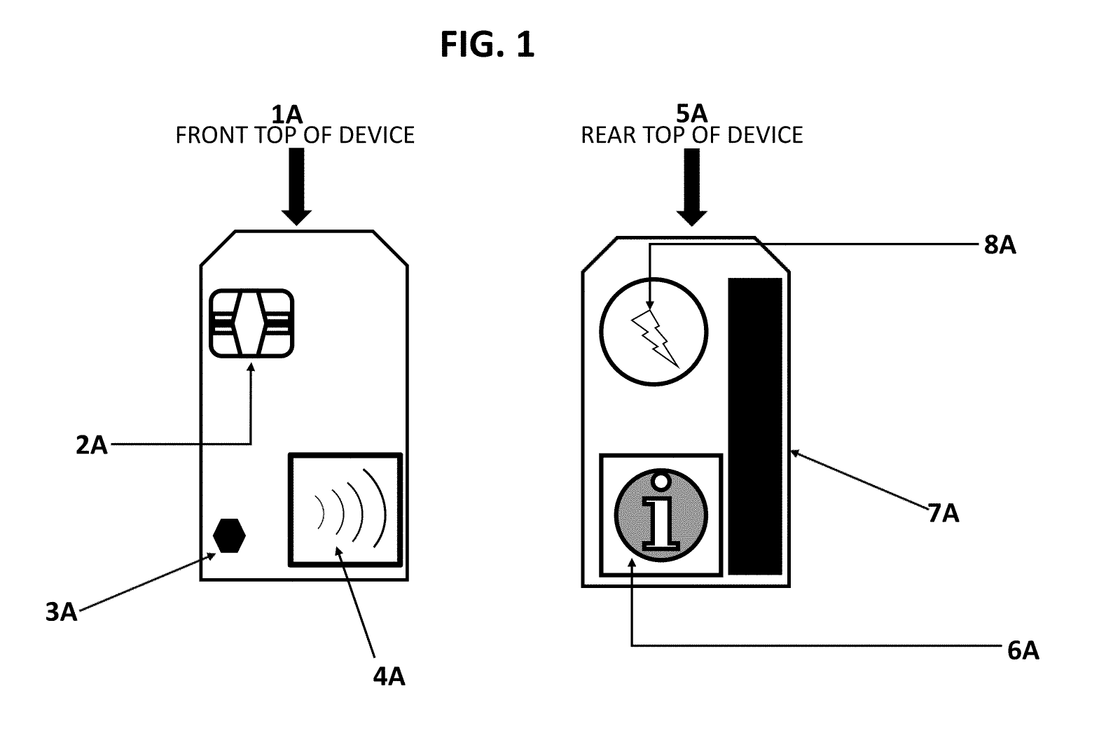

FIG. 1 provides a design for an overview of at least one embodiment 1A illustrates the hardware design for the onetime payment device front containing 2A illustrates the embodiment of, a programmable embedded computer chip that processes the encrypted payment information through chip and pin or EMV payment processing equipped terminals. 3A illustrates the embodiment of, a power indicator or confirmation indicator. 4A illustrates the embodiment of, the contactless receiving processor or Near Field Communication antenna. 5A illustrates the rear of the device and embodiments contained. 6A illustrates the embodiment of, a temporary memory or data processing chip. 7A illustrates the embodiment of, a programmable magnetic stripe that processes the encrypted payment information received through a magnetic reader based payment terminal. 8A illustrates the embodiment of, a power supply device such as a rechargeable or replaceable battery.

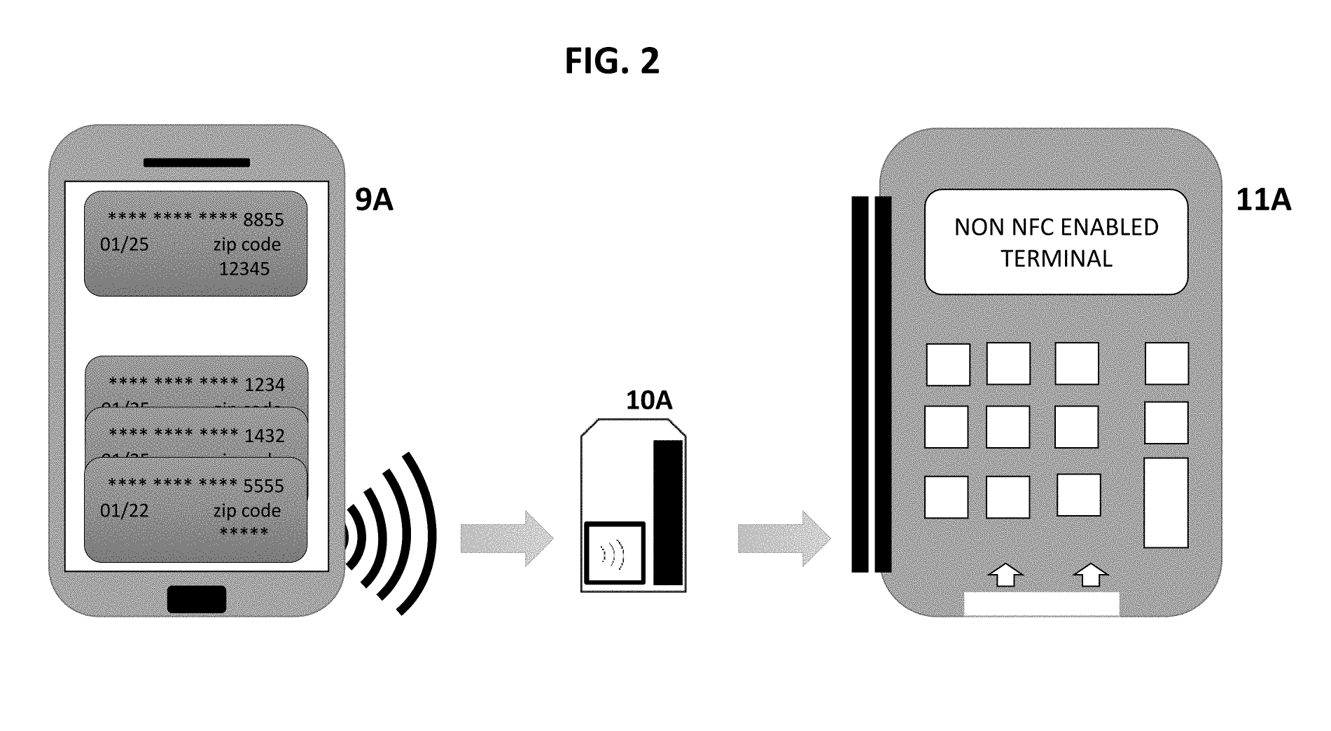

FIG. 2 illustrates the embodiment of, the process use of a 9A NFC enabled smart device equipped with a contactless payment application and the user's payment information loaded into the device, then, initiating the secured payment data transfer. 10A illustrates the embodiment of, a middle device receiving and temporarily holding the secured payment information to be processed. 11A illustrates the embodiment of, the middle device used to transfer and process the secure payment information through the non-enabled point of sale terminal utilizing the common magnetic stripe reader.

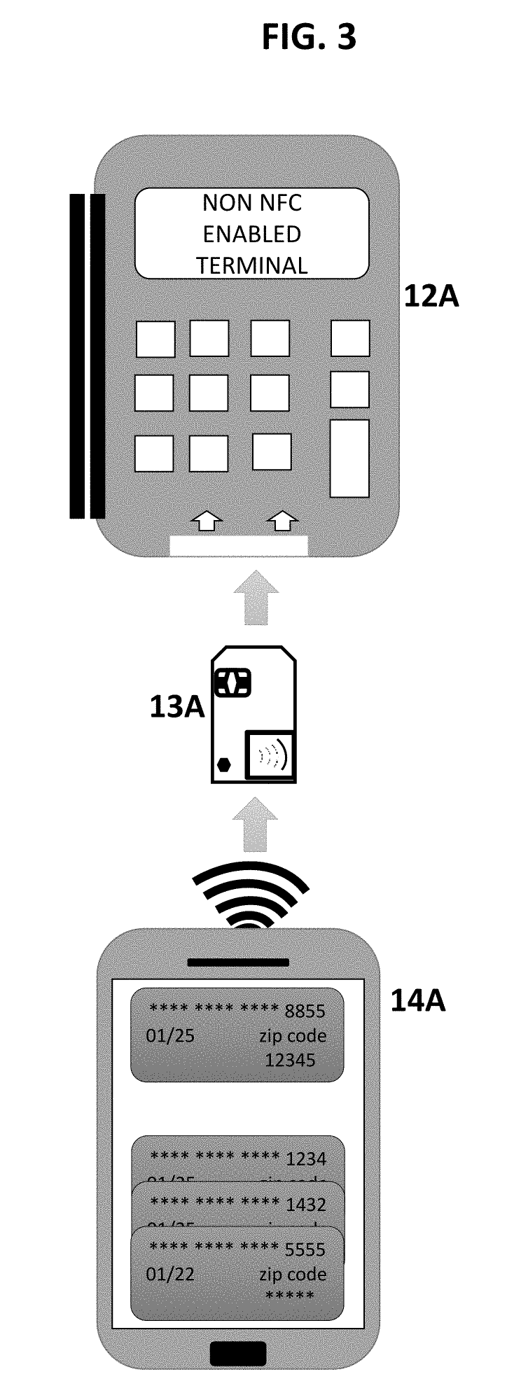

FIG. 3 illustrates the embodiment of, the process use of a 12A NFC enabled smart device equipped with a contactless payment application and the user's payment information loaded into the device, then, initiating the secured payment data transfer. 13A illustrates the embodiment of, a middle device receiving and temporarily holding the secured payment information to be processed. 14A illustrates the embodiment of, the middle device used to transfer and process the secure payment information through the non-enabled point of sale terminal utilizing chip and pin or a EMV (Europay, MasterCard and Visa) payment processing device.

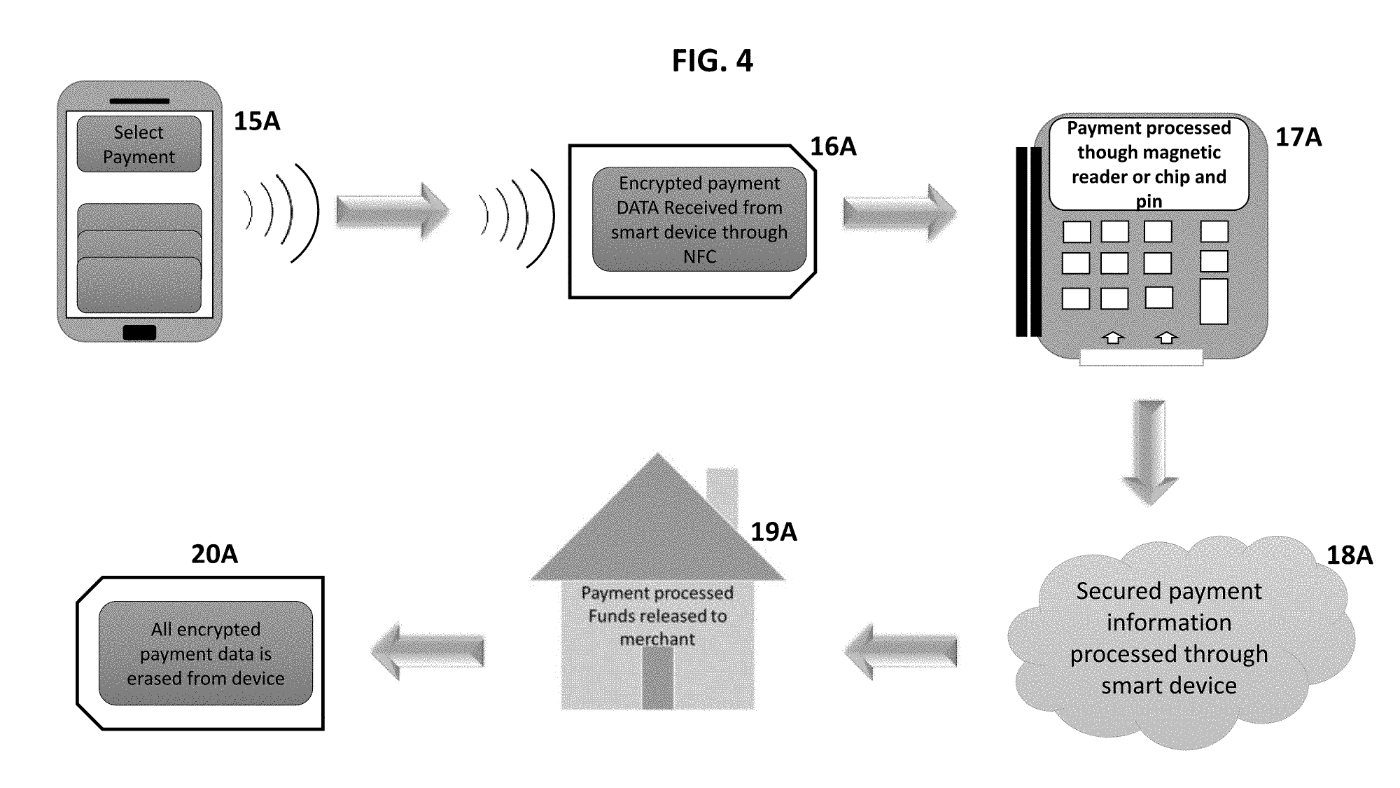

FIG. 4 illustrates the embodiment of, the steps used to further demonstrate a payment processed utilizing the middle device from beginning to end. 15A illustrates the embodiment of the smart NFC enabled device initiating a secured payment. 16A illustrates the embodiment of, the middle device receiving and temporally holding the secured NFC initiated payment card information. 17A illustrates the embodiment of, the NFC enabled middle device transferring the secured payment card information through the non-enabled contactless payment terminal using the magnetic reader or the computer chip EMV processing device. 18A illustrates the embodiment of, the point of sale terminal processing and checking the secured payment information created by the smart device. 19A illustrates the embodiment of, the merchant's payment processing vendor verifying the transaction. 20A illustrates the embodiment of, the middle onetime payment device clearing the secured payment and user card information to reduce the risk of data theft or identity information being compromised after the transactions completion.

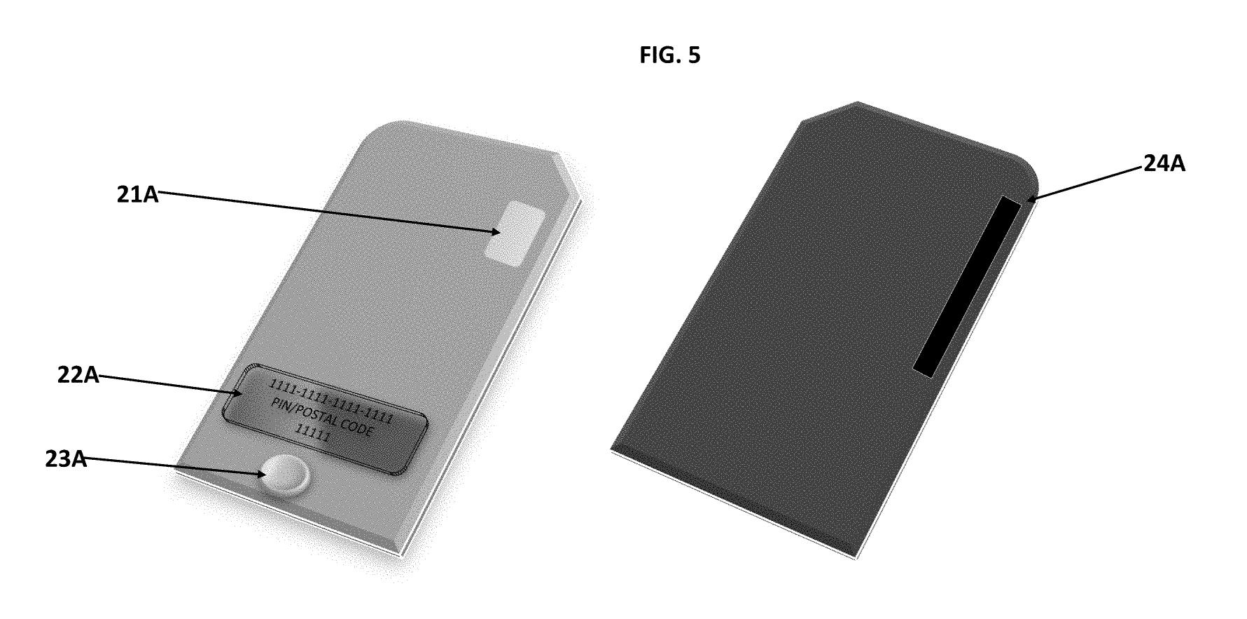

FIG. 5 illustrates the embodiment of, an example front and rear view of the device utilizing a digital display with the random codes used for secure online or face to face transactions. 21A illustrates an example of the programmable contact payment chip. 22A illustrates an example of the digital display showing the single use codes generated by the user's smart device or electronic wallet to assist in reducing the risk of man in the middle or skimming attacks. 23A illustrates an example of the devices activation button or power button. 24A illustrates an example of the programmable magnetic stripe used on out dated terminals to process the secure single use payment.

1. A middle device capable of receiving and processing secured onetime payment transaction data comprising:
a) near field communication receiver antenna;
b) replaceable or rechargeable power supply unit;
c) electronic identification payment contact chip emulation unit;
d) magnetic stripe emulation unit;
e) memory storage unit;
f) data processor unit;
g) digital display unit;
payment processing middle device receives secure encrypted single use data from user's payment software initiated on a smart device or mobile payment electronic wallet.
once the data is generated and received through near field communication, the middle device temporally stores the single use data until the information is processed through a chip and pin or magnetic reader on a point of sale terminal.
after the payment is processed the middle device clears the sensitive payment information until a new transaction is initiated by the user.

2. The device defined in claim 1 containing a programmable ISO/IEC 7816 compliant payment contact chip and magnetic stripe capable of receiving and processing payment data through point of sale terminals that are unable to process standalone near field communication payments.

3. The device defined in claim 1 containing a digital display unit capable of displaying unique codes generated by the application utilized by the smart device or digital wallet to provide further steps in preventing fraudulent activity during face to face or online transactions.

4. The method defined in claim 2 further describes the process of information transferred to the middle device to utilize the payment contact chip or magnetic stripe reader on terminals that are outdated or disabled from receiving direct near field communication payment information.

5. A system defined in claim 3 to display the unique single use codes generated by a NFC or EMV chip payment transaction to allow the use of a smart device or digital wallet payment through online or e-commerce transactions.

6. A method of processing near field communication or NFC initiated credit card and debit card payment transactions on non NFC enabled terminals comprising:
a) User initiating the NFC payment through a digital wallet or smart device;
b) Digital wallet or smart device creates the secured payment information released through the NFC embedded chip;
c) Middle device receives the secured payment information and temporally stores the single use data;
d) Middle device processes the single use secured payment information through the non NFC enabled payment terminals chip and pin or magnetic stripe reader;
